(19) United States
(12) Patent Application Publication
(10) Pub. No.: US 2014/0258852 A1
(43) Pub. Date: Sep. 11, 2014

(54) Detection and Reconstruction of Right-to-Left Text Direction, Ligatures and Diacritics in a Fixed Format Document

(71) Applicant: MIRCROSOFT CORPORATION, Redmond, WA (US)

(72) Inventors: Milan Sesum, Belgrade (RS); Drazen Zaric, Belgrade (RS); Marija Antic, Belgrade (RS); Milos Raskovic, Belgrade (RS)

(73) Assignee: MICROSOFT CORPORATION, Redmond, WA (US)

(21) Appl. No.: 13/794,472

(22) Filed: Mar. 11, 2013

(51) Int. Cl. G06F 17/22

(52) U.S. Cl. CPC G06F 17/2264
USPC 715/256

(57) ABSTRACT

Detection of right-to-left text direction, left-to-right text direction, ligatures and diacritics in fixed format documents for reconstruction of fixed format documents into flow format documents is provided. Each text run of a fixed format document is analyzed for directionality. If text runs contain ligatures, the ligatures are mapped to corresponding characters for proper reading order of the ligatures in context with other characters comprising a text run in which the ligatures are situated or neighboring the ligature. Each text run is collected based on determined text directionality for reconstruction in a flow format document. Proper text directionality for columns of text is determined in the same manner as proper text directionality for text runs in paragraphs of text. If diacritics are present in association with one or more characters or glyphs, a determination may be made as to a carrier character or glyph associated with each diacritic.

### BACKGROUND

Flow format documents and fixed format documents are widely used and have different purposes. Flow format documents organize a document using complex logical formatting objects such as sections, paragraphs, columns, and tables. As a result, flow format documents offer flexibility and easy modification making them suitable for tasks involving documents that are frequently updated or subject to significant editing. In contrast, fixed format documents organize a document using basic physical layout elements such as text runs, paths, and images to preserve the appearance of the original. Fixed format documents offer consistent and precise format layout making them suitable for tasks involving documents that are not frequently or extensively changed or where uniformity is desired. Examples of such tasks include document archival, high-quality reproduction, and source files for commercial publishing and printing. Fixed format documents are often created from flow format source documents. Fixed format documents also include digital reproductions (e.g., scans and photos) of physical (i.e., paper) documents.

In situations where editing of a fixed format document is desired but the flow format source document is not available, the fixed format document may be converted into a flow format document. Conversion involves parsing the fixed format document and transforming the basic physical layout elements from the fixed format document into the more complex logical elements used in a flow format document.

In some cases, text in fixed format documents may be rendered according to a left-to-right reading order (e.g., English language text), or a right-to-left reading order (e.g., some Middle East languages such as Arabic), or a document may have a combination of reading orders. In addition, some fixed format documents may contain ligatures. According to Unicode standard, ligatures may have two forms, including basic and presentational. In general, for each ligature, presentational form consists of one Unicode code component and basic consists of multiple Unicode codes. When a fixed format document contains a presentational form of ligature, it is often replaced with a corresponding basic form because the presentational form often is not processed correctly (i.e., serialized correctly) when converting the fixed format document to a flow format document. In addition, many text items in such documents may have diacritics, such as accent marks over certain characters or glyphs, and some characters may form ligatures.

When converting such fixed format documents to flow format documents, the reading order of the text must be reconstructed according to a proper reading order, or the resulting flow format document will not be readable. In addition, if the reading order is not reconstructed properly in the flow format document, then during subsequent modification of the flow format document, improperly reconstructed text (i.e., improper reading order reconstruction) may not reflow properly resulting in a flow format document that does not comply with the intended reading orders applied to the original document.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing reconstruction of fixed format documents into flow format documents where the fixed format documents contain right-to-left text direction, left-to-right text direction, ligatures and diacritics. According to embodiments, a fixed format document containing one or more text directions is broken into individual text runs. Components of each text run are analyzed for directionality (e.g., right-to-left or left-to-right). Any diacritics contained in the document are next detected. Line detection is next performed, followed by a determination of a logical order of detected text runs comprising each line. The detected lines are organized into corresponding paragraphs. A directionality designation is applied to each paragraph of the document, and a logical directional order of the lines (and included text runs) comprising each paragraph is determined. If text runs contain ligatures, the ligatures are mapped to corresponding characters for proper reconstruction of the ligatures in context with other characters comprising a text run in which the ligatures are situated or neighboring the ligature. If the document has one or more sections of columns, proper text directionality or reading order for the columns is determined in the same manner as proper text directionality is determined for text runs in paragraphs of text.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of one embodiment of a system including a document converter;

FIG. 2 is a block diagram showing an operational flow of one embodiment of a document processor;

FIG. 3A is an illustration of a document containing multiple text directionalities or reading orders;

FIG. 3B is an illustration of a document containing a text run that includes a ligature and a text run that includes a diacritic;

FIGS. 4A and 4B illustrate a flow chart of a method for reconstructing a fixed format document into a flow format document where the fixed format document may include right-to-left text directions, left-to-right text directions, ligatures and diacritics;

FIG. 5 is a block diagram illustrating example physical components of a computing device with which embodiments of the invention may be practiced;

FIGS. 6A and 6B are simplified block diagrams of a mobile computing device with which embodiments of the present invention may be practiced; and

FIG. 7 is a simplified block diagram of a distributed computing system in which embodiments of the present invention may be practiced.

### DETAILED DESCRIPTION

As briefly described above, embodiments of the present invention solve the above and other problems by providing reconstruction of fixed format documents into flow format documents where the fixed format documents may contain right-to-left text direction, left-to-right text direction, ligatures and diacritics. The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

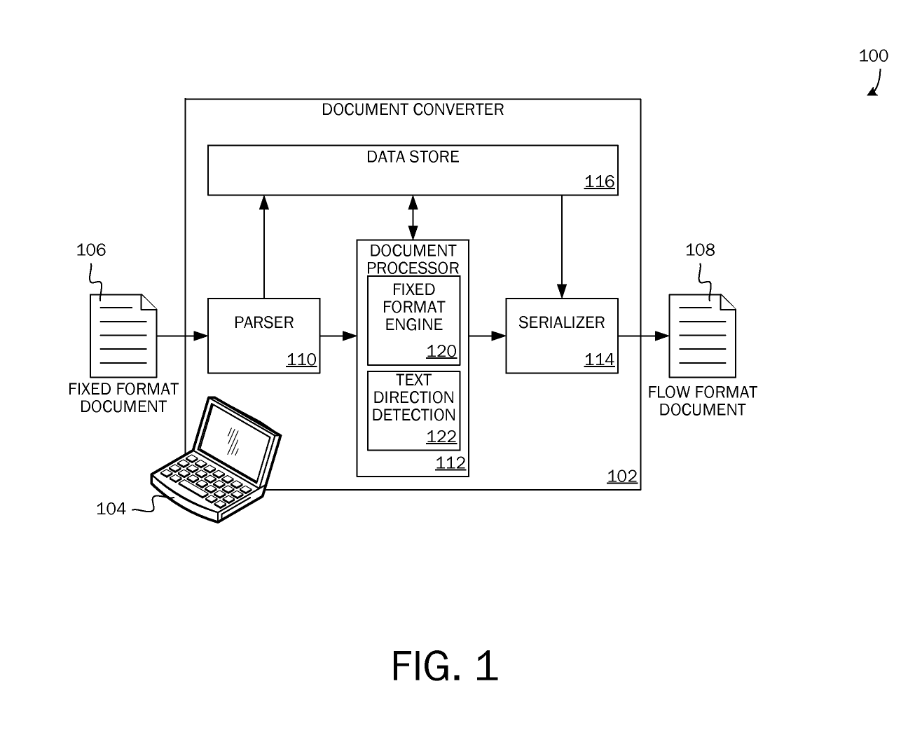

Referring now to the drawings, in which like numerals represent like elements, various embodiments will be described. FIG. 1 illustrates one embodiment of a system 100 incorporating a fixed format detection and flow format reconstruction engine 120 and a text direction detection and reconstruction engine 122. According to embodiments, the fixed format detection and flow format reconstruction engine 120 may include a software module operative to locate lines, paragraphs and other objects of a fixed format document for reconstructing content from a fixed format document into a flow format document. For more information on detection of lines, paragraphs and other objects of a fixed format document for reconstructing content from a fixed format document into a flow format document, see U.S. patent application Ser. No. 13/521,378, filed Jul. 10, 2012, titled “Fixed Format Document Conversion Engine,” U.S. patent application Ser. No. 13/521,407, filed Jul. 10, 2012, titled “Paragraph Property Detection and Style Reconstruction Engine,” and U.S. patent application Ser. No. 13/808,052, filed Jan. 2, 2013 titled “Multi-Level List Detection Engine, each of which are incorporated herein by reference as if fully set out herein. The text direction detection and reconstruction engine 122 may include a software module operative to detect right-to-left text direction, left-to-right text direction, ligatures and diacritics for reconstructing a fixed format document into a flow format document.

In the illustrated embodiment, the fixed format detection and flow format reconstruction engine 120 and the text direction detection and reconstruction engine 122 may operate as part of a document converter 102 executed on a computing device 104. The document converter 102 converts a fixed format document 106 into a flow format document 108 using a parser 110, a document processor 112, and a serializer 114. The parser 110 reads and extracts data from the fixed format document 106. The data extracted from the fixed format document is written to a data store 116 accessible by the document processor 112 and the serializer 114. The document processor 112 analyzes and transforms the data into flowable elements using one or more detection and/or reconstruction engines (e.g., the fixed format detection and flow format reconstruction engine 120 and the text direction detection and reconstruction engine 122). Finally, the serializer 114 writes the flowable elements into a flowable document format (e.g., a word processing format).

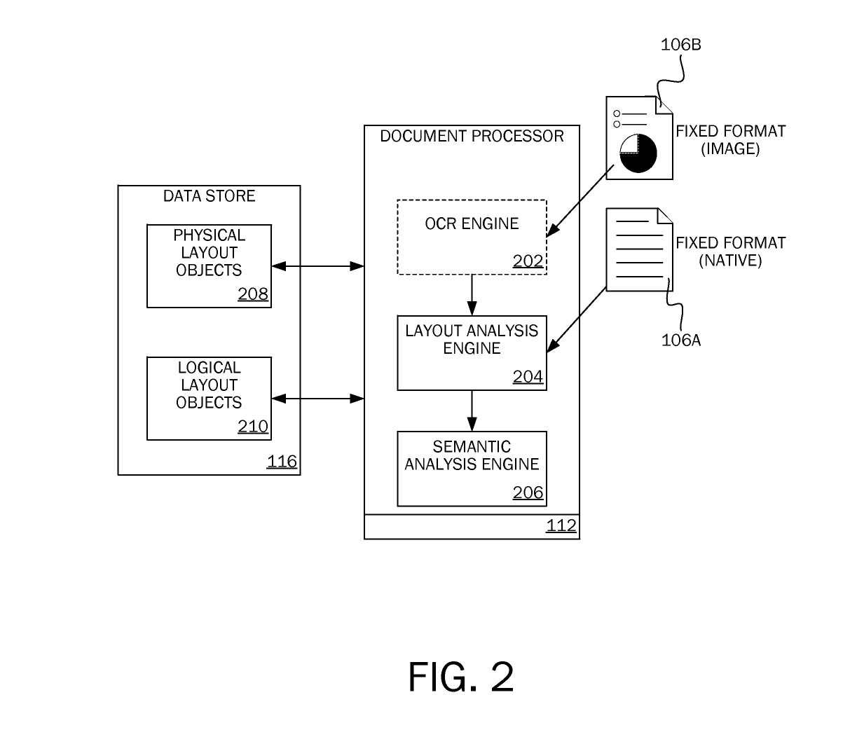

FIG. 2 illustrates one embodiment of the operational flow of the document processor 112 in greater detail. The document processor 112 includes an optional optical character recognition (OCR) engine 202, a layout analysis engine 204, and a semantic analysis engine 206. The data contained in the data store 116 includes physical layout objects 208 and logical layout objects 210. In some embodiments, the physical layout objects 208 and logical layout objects 210 are hierarchically arranged in a tree-like array of groups (i.e., data objects). In various embodiments, a page is the top level group for the physical layout objects 208, while a section is the top level group for the logical layout objects 210. The data extracted from the fixed format document 106 is generally stored as physical layout objects 208 organized by the containing page in the fixed format document 106. The basic physical layout objects 208 include text runs, images, and paths. Text runs are the text elements in page content streams specifying the positions where characters are drawn when displaying the fixed format document. Images are the raster images (i.e., pictures) stored in the fixed format document 106. Paths describe elements such as lines, curves (e.g., cubic Bezier curves), and text outlines used to construct vector graphics. Logical layout objects 210 include flowable elements such as sections, paragraphs, columns, tables, and lists.

Where processing begins depends on the type of fixed format document 106 being parsed. A native fixed format document 106A created directly from a flow format source document contains some or all of the basic physical layout elements. The embedded data objects are extracted by the parser and are available for immediate use by the document converter; although, in some instances, minor reformatting or other minor processing is applied to organize or standardize the data. In contrast, all information in an image-based fixed format document 106B created by digitally imaging a physical document (e.g., scanning or photographing) is stored as a series of page images with no additional data (i.e., no text runs or paths). In this case, the optional optical character recognition engine 202 analyzes each page image and creates corresponding physical layout objects. Once the physical layout objects 208 are available, the layout analysis engine 204 analyzes the layout of the fixed format document. After layout analysis is complete, the semantic analysis engine 206 enriches the logical layout objects with semantic information obtained from analysis of the physical layout objects and/or logical layout objects.

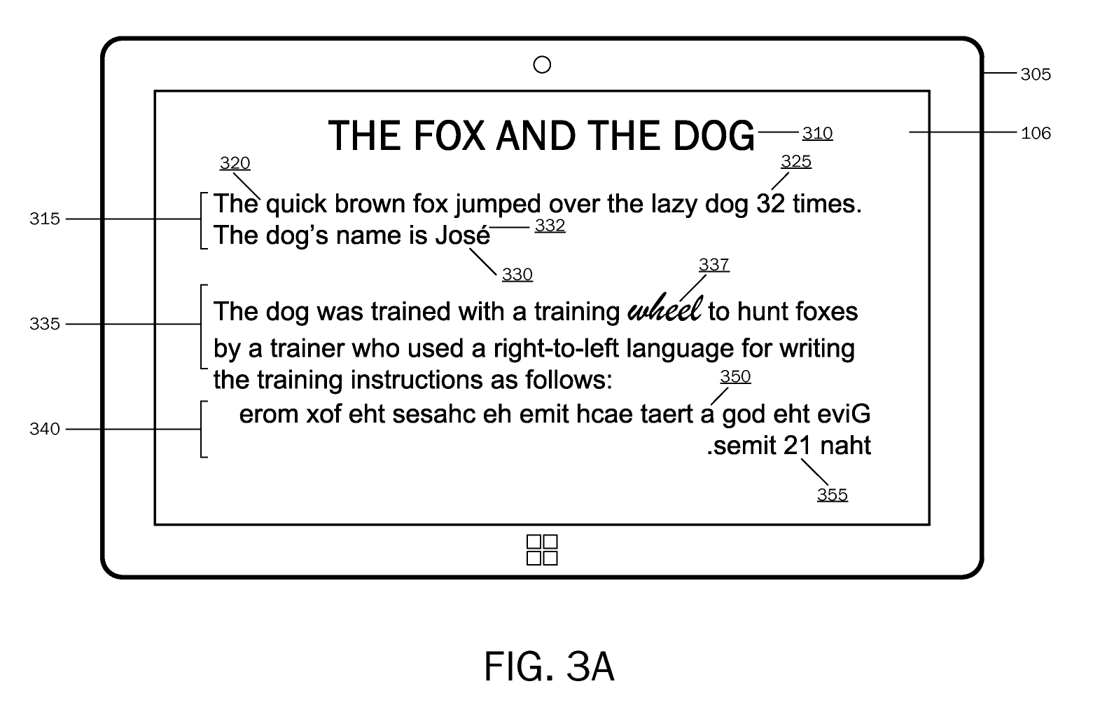

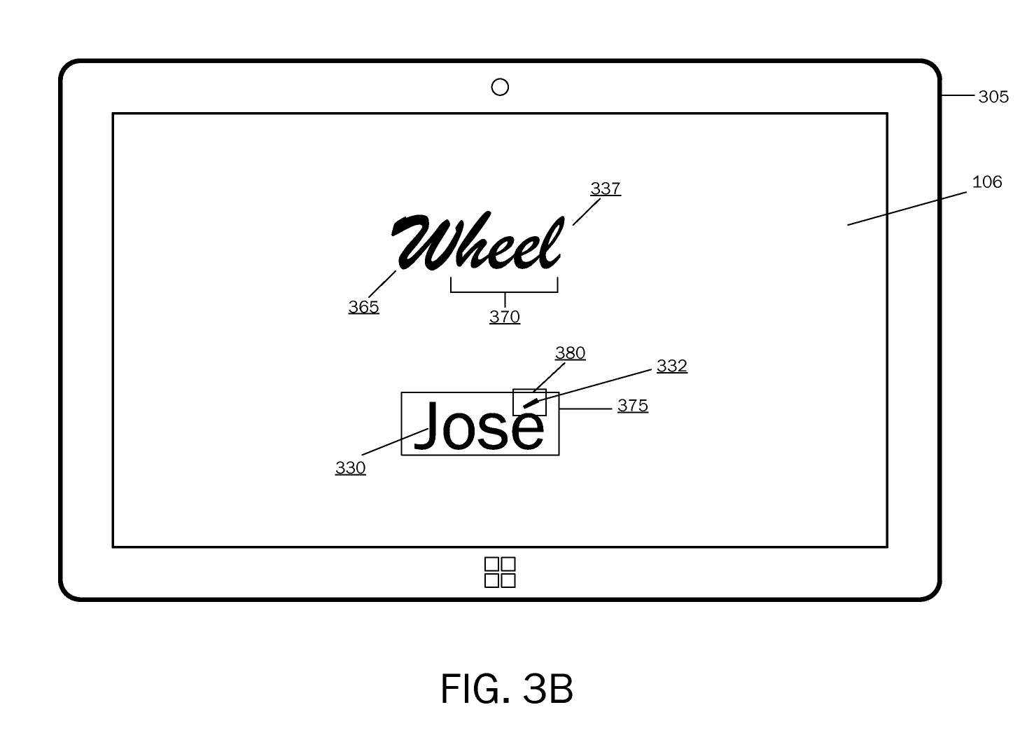

Referring now to FIG. 3A, a fixed format document 106 is illustrated as being displayed on a display surface of a tablet-style computing device 305. As should be appreciated, the tablet-style computing device 305 is but one example of any suitable computing device and associated display on which a fixed format document may be displayed and on which a converted flow format document may be displayed according to embodiments of the present invention.

The fixed format document 106 contains a title 310 and three paragraphs of text 315, 335, 340. The first paragraph of text contains an English language paragraph written in left-to-right reading order. The paragraph 315 is made up of a number of text lines, and each of the text lines is made up of a number of text runs. As should be appreciated, text runs may include single characters, character glyphs, individual words, combinations of an individual word and an adjacent space, combinations of a word followed by a space followed by another word, combinations of words connected to other words via characters and/or glyphs (e.g., hyphens, dots, and the like), or text runs may include a whole line or collection of lines.

The first paragraph 315 includes a number of words, spaces between words 320, numbers 325, and at least one word 330 includes a diacritic 332, for example, an accent mark over the character “e.” The second paragraph 335 includes a number of lines of text written in left-to-right order, and includes at least one word 337 “wheel” that includes a ligature comprised of the letters “heel.”

Referring still to FIG. 3A, a paragraph 340 is illustrated written in right-to-left reading order and containing at least one single character text run 350 and containing a two character number text run 355. As should be appreciated, a number of languages are typically rendered in a left-to-right reading order, as illustrated in paragraphs 315, 335, for example, text written according to the English language. Alternatively, a number of other languages, for example, many Middle East languages such as Arabic and Hebrew, are written in text rendered in a right-to-left reading order. The words illustrated in paragraph 340 are English language words written in a right-to-left orientation for purposes of illustration only and are not intended to represent text belonging to a particular language. Instead, the words (text runs) in paragraph 340 are intended to illustrate treatment of right-to-left text directionality according to embodiments described herein.

Referring now to FIG. 3B, a word 337 is illustrated in a document displayed on the tablet-style computing device comprising a first character 365 in the form of the character “w” and a ligature 370 comprised of the text characters “heel.” The combination of the single character 365 and the ligature 370 combines to form the English language word “wheel” written in cursive text style. As should be appreciated, many languages include ligatures, such as the example ligature illustrated in FIG. 3B. In particular, many languages, for example, many Middle East languages, Eastern languages, and the like, include a variety of rich ligatures comprised of one or more text characters and/or glyphs that are included in various text runs rendered in a document. As described below, in order to assure the proper reconstruction of a fixed format document containing one or more reading orders and containing ligatures, as illustrated in FIG. 3B, such ligatures may be mapped to corresponding characters and/or text runs based on the context of the location of such ligatures for ensuring that reconstruction of the ligatures as part of a flow format document is performed properly in association with the reading order of the corresponding text.

Referring still to FIG. 3B, a word 330 (“Jose”) is illustrated in association with a diacritic 332 in the form of an accent mark over the character “e” that may be included as a text run in a document rendered according to either a right-to-left reading order or a left-to-right reading order. A bounding box 375 is illustrated around the textual characters of the word 330 and a bounding box 380 is illustrated around the accent mark or diacritic 332 positioned above the character “e” of the word 330. As described below, when a text run, for example, the word 330 is included in a fixed format document that must be reconstructed as a flow format document, diacritics such as the accent mark 332 must be accounted for and must be positioned properly relative to associated characters or glyphs with which the diacritics are associated so that when the text run is reconstructed in a flow format document, the diacritics will be positioned properly relative to associated characters and/or glyphs and relative to the determined text directionality or reading order for the text run.

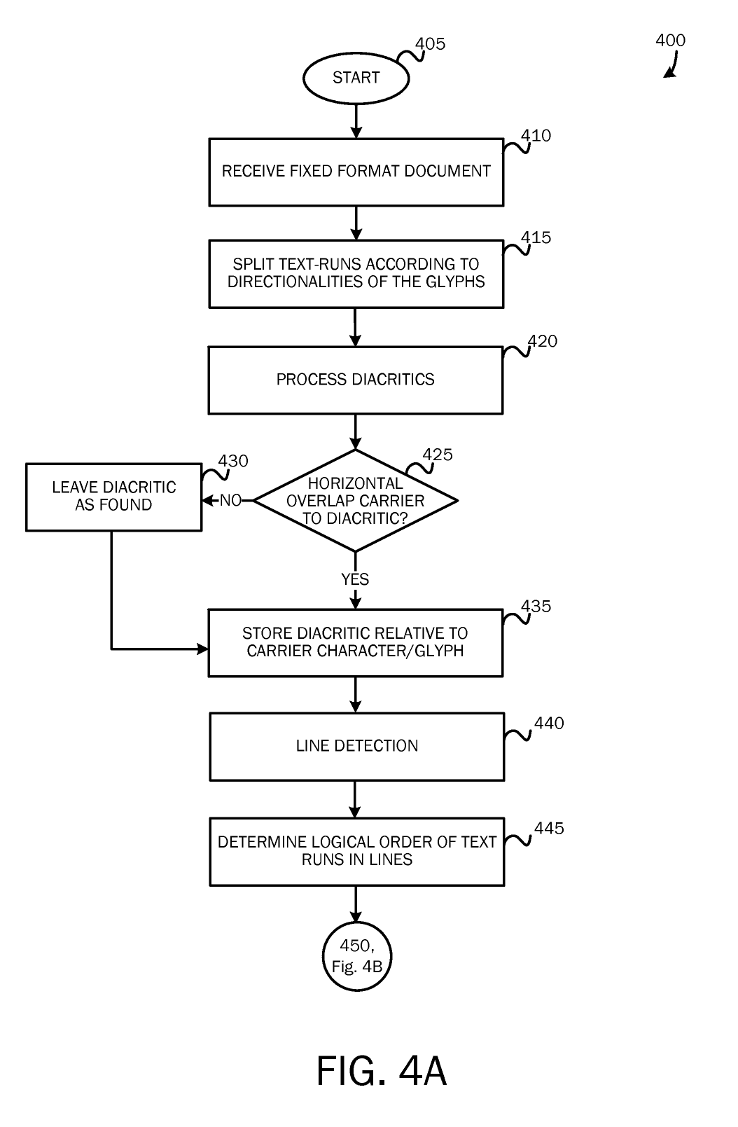

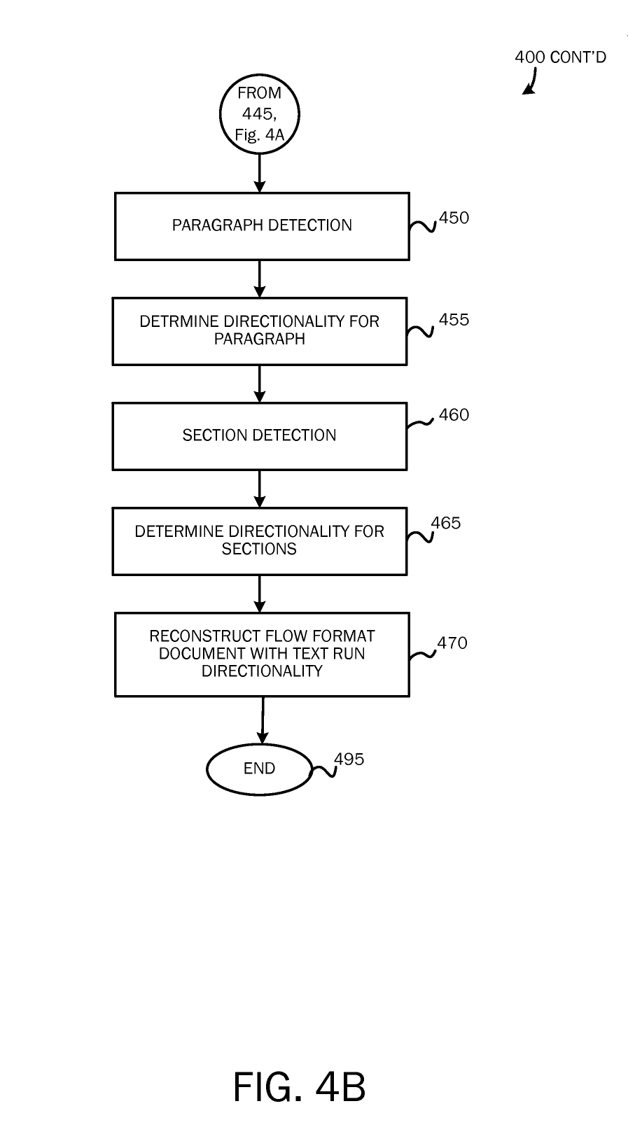

Having described an exemplary operating environment for embodiments of the present invention and example multi-directional text runs with reference to FIGS. 1 through 3 above, FIGS. 4A and 4B illustrate a flow chart of a method for reconstructing a fixed format document into a flow format document where the fixed format document may include right-to-left text directions, left-to-right text directions, ligatures and diacritics. Referring then to FIG. 4A, the method 400 begins at start operation 405 and proceeds to operation 410 where a fixed format document to be reconstructed as a flow format document is received.

At operation 415, the received fixed format document is passed to the parser 110, and the fixed format is divided into individual text runs that are then split apart according to the directionalities associated with individual glyphs comprising the individual text runs. That is, each text run is divided into parts so that each part is unique to the directionality associated with each part. For example, if a given text run has both right-to-left and left-to-right directionality, then the text run will be divided into a right-to-left part and a left-to-right part.

According to an embodiment of the invention, the fixed format document may be broken into text runs by the document converter 102 using the parser 110, the document processor 112, as described above with reference to FIG. 1. As should be appreciated, a number of methods may be used by the parser 110, the document processor 112 for breaking the received text into text runs. According to one embodiment, each text run may be broken into individual words or individual characters, and the individual words and/or characters may be compared against libraries of words and/or characters for determining whether extracted words and/or characters match known words. In addition, spaces and punctuation marks may be used for assisting the document processor 112 in association with the parser 110 into separating the lines in the individual text runs including individual words, combinations of words, and the like.

As described above, a text run may be one of a number of different components of a text string, for example, a single character, a single word, a single word followed by or preceded by a space, a word followed by a space followed by another word, a whole sentence, or a plurality of sentences. That is, a text run may be a number of different combinations of words, numerals, spaces, punctuation marks, and the like that combine together to generate a meaningful text string that may be used as a written element of a given language and that may be analyzed for determining text directionality or reading order of a given text run, as described herein. Referring back to FIG. 3A, the text provided in the fixed format document 106 includes three paragraphs 315, 335, 340. Each paragraph is comprised of a number of lines, and each line of each paragraph is comprised of a number of text runs including words, spaces, numerals, and the like.

In addition to identifying one or more text runs in the received fixed format document, text runs in the form of ligatures also may be detected during the document parsing process. As illustrated and described above with reference to FIGS. 3A and 3B, a ligature may be in the form of a blending of characters or glyphs to form a text component that may be used by a variety of languages as a useful text component. For example, referring to FIG. 3B, the word “wheel” is comprised of a single character “w” separated by a small amount of space from a ligature comprised of the characters “h, e, e, l” that are physically blended together as a single text component (“heel”). As described below, because such ligatures may be present among various text runs rendered according to a particular text direction, for example, right-to-left directionality, such ligatures must be accounted for when determining text directionality of the text runs contained in a received fixed format document, so that reconstruction of the document as a flow format document will be performed correctly.

Before character and text run directionality may be determined for the various text runs comprising the received fixed format document, a pre-processing may be performed on the text runs parsed from the received fixed format document for separating the parsed text runs according to different directionalities associated with various text runs. That is, because text runs may have characters of different directionalities, a determination as to different types of directionalities that may be present in the various text runs may be necessary before determining the number of text runs parsed from the document that have strong text directionality.

A determination may next be begun with respect to each parsed text run for determining whether one of four types of directionality may be associated with each text run, characters comprising a text run, or other components such as ligatures. According to an embodiment, four types of directionality may be determined for each text run or components of each text run. A first type of directionality is right-to-left directionality which is associated with certain languages, for example, Middle East languages like Arabic. A second type of text directionality that may be applied to a given text run or component thereof is a left-to-right directionality that is associated with certain languages, for example, the English language. A third type of directionality is a neutral directionality which is associated with text components such as spaces between words, punctuation marks, or other text components that are not particular to a given text directionality. A fourth type of text directionality is a weak directionality which is typically associated with numbers contained in or associated with a given text run.

At operation 420, any diacritics present in the received fixed format document may be processed for applying an appropriate text directionality to each diacritic so that the diacritic will be reconstructed in a flow format document according to a proper text directionality. When processing the document for diacritics at operation 420, each page of the received fixed format document is parsed for obtaining diacritics found on the page. For example, referring back to FIG. 3B, a word “José” is parsed from the received fixed format document, and a diacritic 332, for example, an accent mark, is located. During the parsing process, the text direction detection engine 122 attempts to locate carriers for each located diacritic. For example, referring to FIG. 3B, the carrier for the diacritic (accent mark) 332 is the letter “e” at the end of the word 330. Thus, during parsing the text direction detection engine 122 attempts to find each diacritic and each carrier associated with each diacritic.

Referring still to FIG. 3B, the text direction detection engine 122 analyzes bounding boxes associated with each displayed text component, for example, the bounding box 380 that bounds the diacritic 332 and the bounding box 375 that bounds the word 330. At operation 425, a determination is made as to whether horizontal overlap exists between a bounding box of an identified diacritic and a bounding box of an associated carrier. If such horizontal overlap between the bounding boxes of the diacritic and a carrier exists, then the method proceeds to operation 435, and the diacritic and carrier character or carrier glyph bounded by horizontally overlapping bounding boxes is stored right after (e.g., on the right side) of the carrier character or carrier glyph at operation 435.

If the carrier character or carrier glyph contains multiple characters (i.e., it forms a ligature), it may be necessary to determine which character in a carrier glyph carries the diacritic. In such a case, the text direction detection engine 122 may estimate the character bounding boxes by dividing the bounding box of the carrier glyph with the total number of characters. Then, a search for the horizontal overlap of the diacritic bounding box with the estimated or calculated character bounding boxes may be performed, and the diacritic may be stored within the glyph string immediately after the carrier character or carrier glyph. In the case of right-to-left text directionality, the diacritic may be stored just after the carrier (i.e., to the left of the carrier).

Referring back to operation 425, if horizontal overlap between the bounding box 380 for an identified diacritic does not horizontally overlap with a bounding box 375 for an associated carrier, character or glyph, the method 400 proceeds to operation 430, and the diacritic is left where it is found during the initial parsing process for locating diacritics from the fixed format document.

At operation 440, the fixed format document may be broken into individual lines for aiding and analyzing text runs comprising individual lines. The engine 120 may break received text into individual lines using well-known attributes of text lines. For example punctuation marks like periods followed by one or more spaces may indicate the ending of one line followed by the beginning of another line. Such attributes of a given text run may be used by the fixed format detection and flow format reconstruction engine 120 for breaking a given paragraph into one or more lines.

According to an embodiment, at operation 445, the text direction engine 122 may place each text run parsed from the received document in a bucket with other text runs that share the same text directionality. That is, the “bucket” represents a logical grouping of text runs that are related to each other based on common text directionality. During the parsing process performed by the document processor for parsing and extracting one or more text runs, a determination may be made as to the text directionality of each parsed text run. For example, text runs identified as words during the parsing process may be compared with libraries of words for determining whether those words belong to a left-to-right reading order or a right-to-left reading order. As each text run or word is identified as belonging to a particular order, such defined words may be stored in a logical relationship with other words having the same text directionality.

Such text runs or words defined according to a particular text directionality would be considered as having strong text direction because those text runs or words may be defined according to one of the two particular text directions. For example, referring back to FIG. 3A, words parsed from text runs comprising the first two paragraphs 315 and 335 may be identified as left-to-right reading order by matching each parsed word against libraries of known words belonging to a left-to-right reading order. Similarly, the text runs including words comprising the third paragraph 340 may be identified as belonging to a right-to-left text order by comparing those words against dictionaries or other repositories of words utilized according to languages that are rendered in a right-to-left text order.

In addition to placing each text run defined according to a particular text directionality in a logical definitional association (“bucket”) with other similarly designated text runs, text runs defined according to neutral or weak text directionalities may likewise be stored in a bucket with other text runs of the same text directionality. According to one embodiment, weak and neutral text runs may be stored in the same bucket or logical association for subsequent analysis.

According to an embodiment, it is not a problem to have neutral directionality text runs and/or weak directionality text runs in the same text run as left-to-right text runs. That is, having a neutral and/or weak text directionality text run with a left-to-right does not present a problem in reconstructing the text run into a flow format document because those text runs of weak and/or neutral text directionality do not create reflow problems with left-to-right text runs in the subsequently reconstructed flow format document. Thus, according to an embodiment, the text directionality engine 122 may split out only the text runs with right-to-left text directionality plus characters or text runs of some other directionality. For example, useful combinations of text runs grouped together include right-to-left text runs grouped with neutral text runs, right-to-left text runs grouped with weak text runs, right-to-left plus left-to-right text runs, or various combinations thereof.

For example, considering the text string “CIBARA1234,” according to embodiments described herein, the example text string would be split into two text runs of “CIBARA” and “1234.” This split is performed because the alphabetical characters of the starting text string are in right-to-left directionality, but the numerical string is of a weak text directionality. Thus, without splitting the text string, as described, the text string may erroneously be converted to a string such as “4321ARABIC” when the correct conversion would read “1234ARABIC.”

At operation 450, the received fixed format document is broken into paragraphs by the fixed format detection and flow format reconstruction engine 120 described above with reference to FIG. 1. As should be appreciated, the received fixed format document may be broken into one or more paragraphs according to a variety of different methods. For example, all lines in the received fixed format document 106 running continuously between line spaces may be considered a paragraph. That is, groupings of lines followed by a line space followed by a second grouping of lines followed by another line space, and so on may be utilized for information for determining that each of the groupings is a paragraph. Other indicia that may be used for determining that a given set of lines is a paragraph includes paragraph indentions or one or more annotations that may be applied to a group of lines to indicate that the lines may belong together as a paragraph.

At operation 455, the text directionality engine 122 determines a number of left-to-right and right-to-left characters and/or text runs that are present in each paragraph 315, 335, 340 of the received fixed format document 106. If a given paragraph, for example, paragraph 315, has a greater count of right-to-left characters and/or text runs, then the engine 122 designates the paragraph as a right-to-left text directionality paragraph. Alternatively, if the analyzed paragraph contains a greater count of left-to-right characters and/or text runs, then the text direction detection engine 122 will designate the paragraph as a left-to-right text directionality paragraph. As should be appreciated, the process of designating individual text runs and paragraphs according to a particular text directionality further assists the text direction detects in engine 122 in ultimately reconstructing the received fixed format document 106 according to appropriate text directionalities that are applied to individual text runs, lines, and paragraphs in the received document.

Based on the directionality counts determined for characters and/or text runs in each paragraph, each parsed and analyzed paragraph in the received fixed format document 106 is designated as either a left-to-right text direction paragraph or a right-to-left text direction paragraph. At operation 455, after paragraph directionality is designated, as described above, the text direction detection engine 122 next determines a logical order of text runs inside each designated paragraph. For determining a logical order of text runs, each bucket of text runs is analyzed, and each text run that has a neutral or weak text direction is designated with a strong directionality. As mentioned above, neutral and/or weak direction text runs may be stored together in the same storage bucket. As should be appreciated, the application of a strong directionality (i.e., right-to-left or left-to-right) is necessary so that each neutral and/or weak text run may be associated with other text runs of particular strong text directions.

For application of a strong directionality to each neutral and/or weak text run, if a given neutral or weak text run is between two right-to-left text runs, then the strong text directionality of right-to-left is set on the analyzed neutral or weak text run. Alternatively, if a given neutral or weak text run is between two left-to-right text runs, then a strong text directionality of left-to-right is set on the analyzed neutral or weak text run. If a given analyzed neutral or weak text run is not between two strong text directionality text runs, then the text directionality designated for the paragraph from which the analyzed neutral or weak text run was parsed is set on the analyzed text run. That is, if an analyzed neutral or weak text run is not positioned between two strong text directionality text runs, then a text directionality designated for the paragraph from which the neutral or weak text run is parsed is set on that text run.

After strong text directionality has been designated for each paragraph and each text run, including the neutral and/or weak text direction text runs, each text run is collected into a logical order for ultimate reconstruction of the text runs into lines and paragraphs in a flow format document according to appropriate text directionality. First, if the paragraph text directionality associated with a collection of text runs is right-to-left, then the text direction detection engine 122 may go through all lines in the paragraph, and in each line, may collect all text runs that have right-to-left text direction in a right-to-left collection order. Alternatively, if the paragraph directionality is left-to-right, then the text direction detection engine 122 may go through all lines of the paragraph, and in each line, may collect all text runs that have left-to-right text direction in a left-to-right collection order. That is, by collecting each text run according to the appropriate text directionality order, then each text run is arranged logically according to the appropriate text direction so that when the text runs are reconstructed into a flow format document, they will reflow correctly when modified or otherwise edited as part of the flow format document.

In some cases, a received fixed format document 106 may include sections comprised of one or more columns of text and/or numbers. For example, in a letter, memorandum or other document, text may be arranged in a series of paragraphs and lines, but in various places in the document, sections may be included comprised of columns of text or numbers presented as data or other interesting information to the reader. At operation 460, the text direction detection engine 122 processes any sections of the received fixed format document containing text runs organized in columns. According to embodiments, if the received fixed format document has one or more document sections comprised of columns of text runs, then at operation 465, the text direction detection engine 122 determines a text directionality for the entire section because reading order of such a section depends on text direction applied to the section.

According to one embodiment if the section has a left-to-right text directionality, then the columns of text runs will be rendered or displayed in the same order (i.e., left-to-right). On the other hand, if a section has a right-to-left directionality, then the columns will be displayed in that same order (i.e., right-to-left). Text directionality for a document section comprised of columns of text runs is determined in the same manner as for paragraphs, lines and text runs described above. That is, if more right-to left characters are present in a given section, then the section will be designated as a right-to-left text directionality. Alternatively, if more left-to-right characters are present in a section, then a left-to-right text directionality will be designated for the section.

As described above with reference to FIG. 3B, some text runs contained in paragraphs and/or sections containing columns of text runs are in the form of ligatures which may be collections of characters and/or glyphs combined together to form a useful text component according to a particular language. For both paragraphs and sections of columns, a text directionality is applied to text runs determined to be ligatures by mapping those ligatures to corresponding characters in the text runs of the document for determining a context of the ligatures and for determining a text directionality to be applied to the ligatures. For example, considering the ligature 370 illustrated in FIG. 3B, the ligature may be mapped to the characters contained in the text run comprising the word “wheel” and a context for the ligature comprising a portion of the word may be utilized for determining that the ligature is associated with the word “wheel,” and thus, a text directionality may be applied to the ligature in association with the word to which it is associated and in association with other text runs around it as described above for designation of text directionalities to individual text runs comprising paragraphs of the received fixed format document.

At operation 470, the paragraphs, lines, text runs, ligatures, and diacritics may be reconstructed as a flow format document of the received fixed format document, and text directionality applied to each of such text components may be followed during reconstruction so that the flow format document will be reconstructed to allow for editing and/or modification according to the designated text directionality for each text component so that the text components will properly reflow during editing and/or other modification. The method 400 ends at operation 495.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

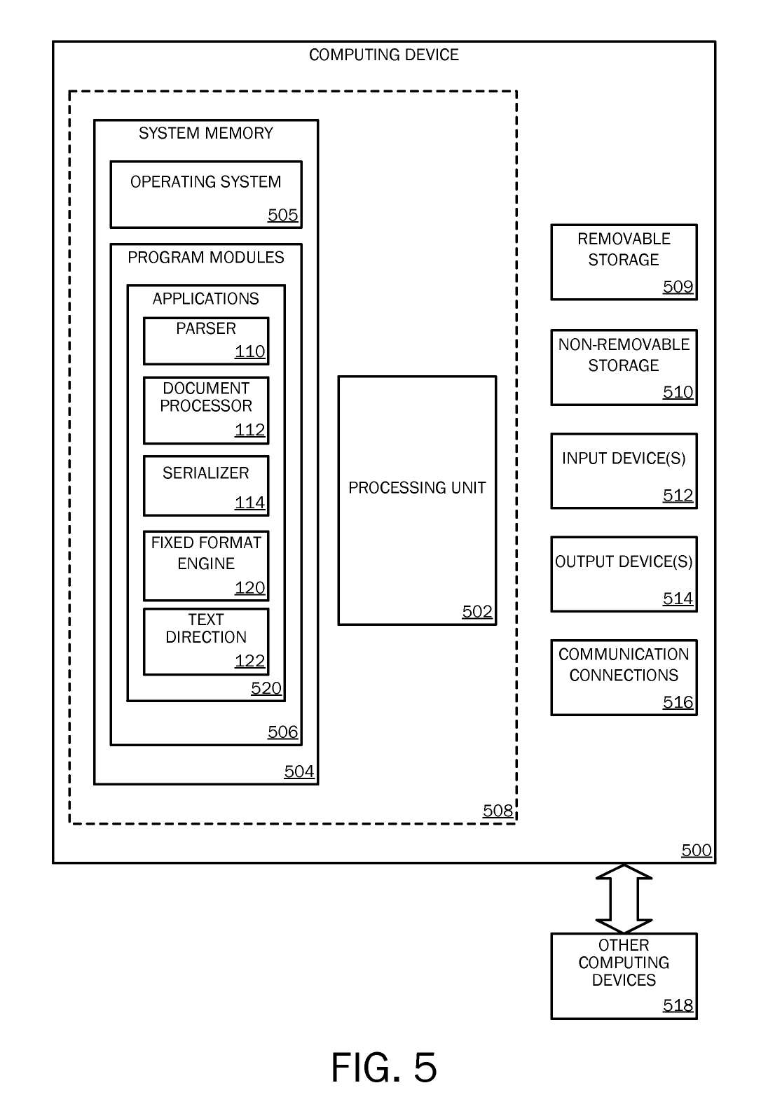

FIGS. 5-7 and the associated descriptions provide a discussion of a variety of operating environments in which embodiments of the invention may be practiced. However, the devices and systems illustrated and discussed with respect to FIGS. 5-7 are for purposes of example and illustration and are not limiting of a vast number of computing device configurations that may be utilized for practicing embodiments of the invention, described herein.

FIG. 5 is a block diagram illustrating physical components (i.e., hardware) of a computing device 500 with which embodiments of the invention may be practiced. The computing device components described below may be suitable for the computing devices described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running software applications 520 such as the fixed format detection and flow format reconstruction engine 120 and the text direction detection and reconstruction engine 122, the document processor 112, the parser 110, the document converter 102, and the serializer 114. The operating system 505, for example, may be suitable for controlling the operation of the computing device 500. Furthermore, embodiments of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., the fixed format detection and flow format reconstruction engine 120 and the text direction detection and reconstruction engine 122, the parser 110, the document processor 112, and the serializer 114) may perform processes including, but not limited to, one or more of the stages of the method 400 illustrated in FIG. 4. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the fixed format detection and flow format reconstruction engine 120, the text direction detection and reconstruction engine 122, the parser 110, the document processor 112, and the serializer 114 may be operated via application-specific logic integrated with other components of the computing device 500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, or serial ports, and other connections appropriate for use with the applicable computer readable media.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media and communication media. Computer storage media may include volatile and nonvolatile, removable and non-removable media implemented in any method or technology for storage of information, such as computer readable instructions, data structures, program modules, or other data. The system memory 504, the removable storage device 509, and the non-removable storage device 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Any such computer storage media may be part of the computing device 500.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

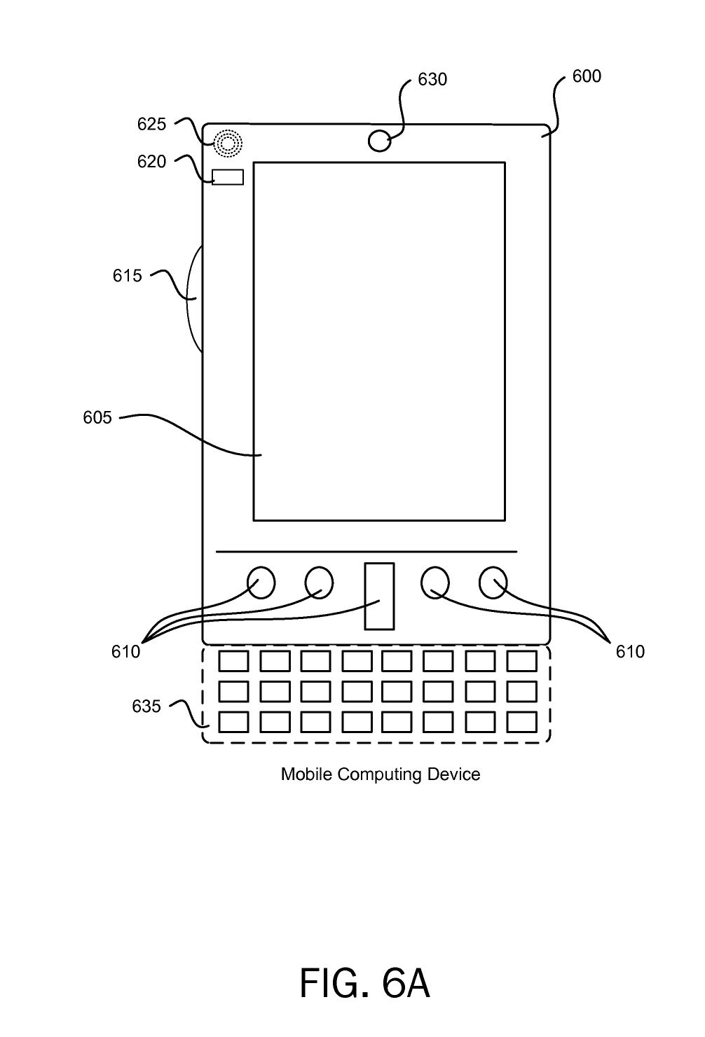

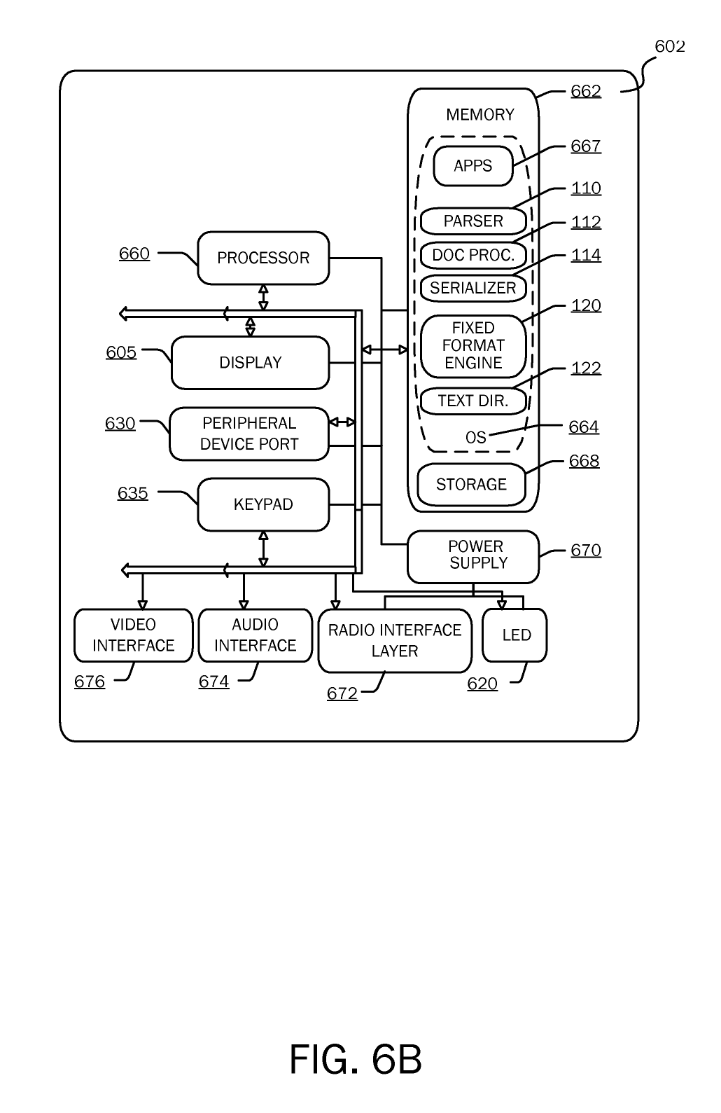

FIGS. 6A and 6B illustrate a mobile computing device 600, for example, a mobile telephone, a smart phone, a tablet personal computer, a laptop computer, and the like, with which embodiments of the invention may be practiced. With reference to FIG. 6A, one embodiment of a mobile computing device 600 for implementing the embodiments is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs 667 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 667 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including the fixed format detection and flow format reconstruction engine 120, the text direction detection and reconstruction engine 122, the parser 110, the document processor 112, and the serializer 114 described herein.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 667 via the operating system 664, and vice versa.

The radio 672 allows the system 602 to communicate with other computing devices, such as over a network. The radio 672 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 602 provides notifications using the visual indicator 620 that can be used to provide visual notifications and/or an audio interface 674 producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668. Computer storage media may include volatile and nonvolatile, removable and non-removable media implemented in any method or technology for storage of information, such as computer readable instructions, data structures, program modules, or other data.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

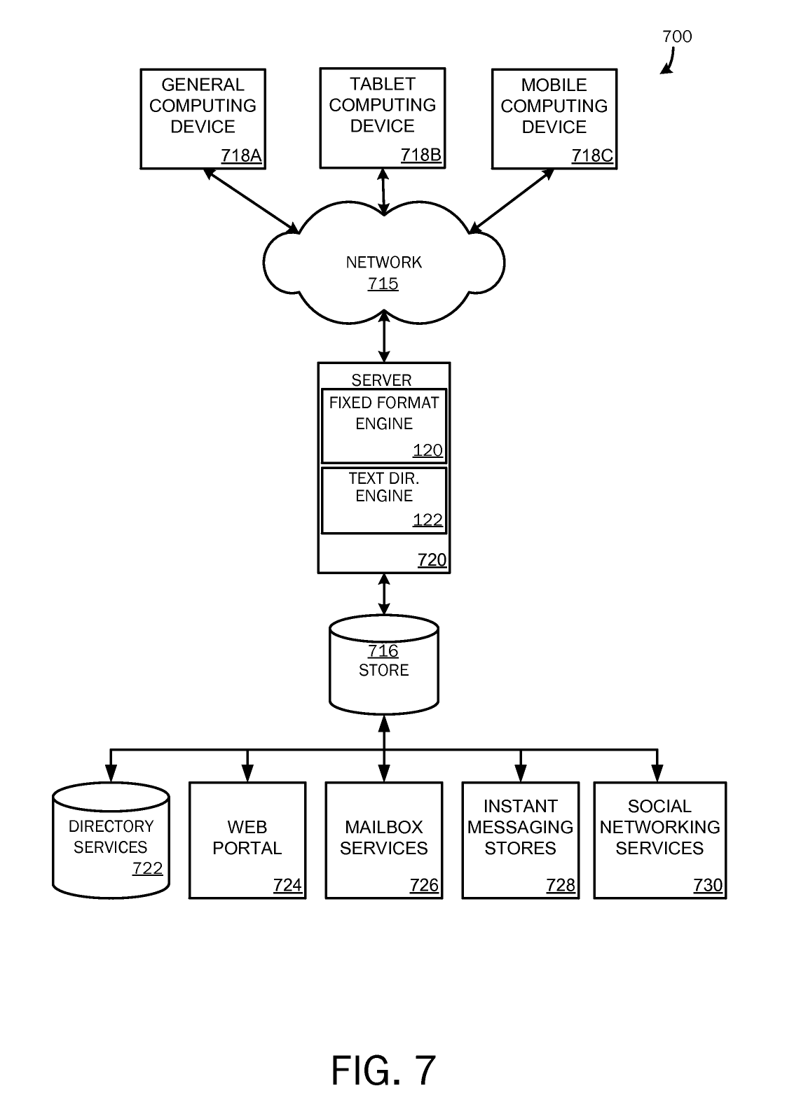

FIG. 7 illustrates one embodiment of the architecture of a system 700 for providing detection of right-to-left text direction, left-to-right text direction, ligatures and diacritics in a fixed format document 106 to one or more client devices, as described above. Content developed, interacted with, or edited in association with the fixed format detection and flow format reconstruction engine 120, the text direction detection and reconstruction engine 122, the parser 110, the document processor 112, and the serializer 114 may be stored in different communication channels or other storage types. For example, various documents may be stored using a directory service 722, a web portal 724, a mailbox service 726, an instant messaging store 728, or a social networking site 730. The fixed format detection and flow format reconstruction engine 120, the text direction detection and reconstruction engine 122, the parser 110, the document processor 112, and the serializer 114 may use any of these types of systems or the like for enabling data utilization, as described herein. A server 720 may provide the fixed format detection and flow format reconstruction engine 120, the text direction detection and reconstruction engine 122, the parser 110, the document processor 112, and the serializer 114 to clients. As one example, the server 720 may be a web server providing the fixed format detection and flow format reconstruction engine 120, the text direction detection and reconstruction engine 122, the parser 110, the document processor 112, and the serializer 114 over the web. The server 720 may provide the fixed format detection and flow format reconstruction engine 120, the text direction detection and reconstruction engine 122, and the serializer 114 over the web to clients through a network 715. By way of example, the client computing device 718 may be implemented as the computing device 500 and embodied in a personal computer 718a, a tablet computing device 718b and/or a mobile computing device 718c (e.g., a smart phone). Any of these embodiments of the client computing device 718 may obtain content from the store 716.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method of detecting text direction in a fixed format document for reconstruction of a flow format document; comprising:
breaking the fixed format document into one or more text runs;
determining a text run directionality for each of the one or more text runs;
collecting each of the one or more text runs according to a text run directionality determined for each of the one or more text runs; and
reconstructing the fixed format document as a flow format document wherein each of the one or more text runs reconstructed in the flow format document are reconstructed according to the designated text run directionality designated for each of the one or more text runs.

2. The method of claim 1, wherein collecting each of the one or more text runs according to a text run directionality determined for each of the one or more text runs includes collecting each of the one or more text runs based on a right-to-left directionality or based on a left-to-right directionality.

3. The method of claim 1, wherein determining a text run directionality for each of the one or more text runs includes determining a right-to-left directionality for one or more of the one or more text runs.

4. The method of claim 3, wherein determining a text run directionality for the one or more text runs includes determining a left-to-right directionality for one or more of the one or more text runs.

5. The method of claim 4, wherein determining a text run directionality for one or more text runs includes determining a neutral directionality for one or more of the one or more text runs.

6. The method of claim 5, wherein determining a text run directionality for one or more text runs includes determining a weak directionality for one or more of the one or more text runs.

7. The method of claim 6, further comprising designating a weak or neutral text run positioned between two right-to-left text runs as a right-to-left text run.

8. The method of claim 7, further comprising designating a weak or neutral text run positioned between two left-to-right text runs as a left-to-right text run.

9. The method of claim 8, wherein if a weak or neutral text run is not positioned between two right-to-left text runs or two left-to-right text runs, designating the weak or neutral text run with a text directionality designated for a paragraph from which the weak or neutral text run is extracted.

10. The method of claim 1, after breaking the one or more lines into one or more text runs, breaking the fixed format document into one or more paragraphs.

11. The method of claim 10, further comprising determining a text directionality of each of the one or more paragraphs.

12. The method of claim 11, wherein determining a text directionality for each of the one or more paragraphs includes designating one or more of the one or more paragraphs as a left-to-right paragraph if the one or more of the one or more paragraphs has more left-to-right text runs than right-to-left text runs.

13. The method of claim 12, wherein determining a text directionality of each of the one or more paragraphs includes designating one or more of the one or more paragraphs as a right-to-left paragraph if the one or more of the one or more paragraphs has more right-to-left text runs than left-to-right text runs.

14. The method of claim 1, wherein the one or more text runs includes one or more ligatures.

15. The method of claim 14, further comprising determining a text directionality of the one or more ligatures based on a context of the one or more ligatures relative to a text directionality of text runs associated with the one or more ligatures.

16. The method of claim 1, further comprising
determining a text directionality for one or more sections in the fixed format document, the sections containing one or more columns of text runs; and
wherein collecting each of the one or more text runs according to a text run directionality determined for each of the one or more text runs includes collecting each of one or more text runs contained in the one or more sections according to a text run directionality determined for each of the one or more text runs contained in the one or more columns of text runs.

17. The method of claim 1,
wherein breaking the fixed format document into one or more text runs includes parsing the fixed format document for one or more diacritics contained in the fixed format document; and
wherein collecting each of the one or more text runs according to a text run directionality determined for each of the one or more text runs includes collecting any diacritics associated with any of the collected text runs.

18. The method of claim 17, wherein for each diacritic parsed from the fixed format document, if a bounding box containing a given diacritic horizontally overlaps with a bounding box containing a carrier character or a carrier glyph, designating the given diacritic for reconstruction with the carrier character or carrier glyph when the fixed format document is reconstructed as a flow format document, wherein the given diacritic is assigned a text directionality of the carrier character or carrier glyph.

19. A computer readable medium containing computer executable instructions which when executed by a computer perform a method of detecting text direction in a fixed format document for reconstruction of a flow format document; comprising:
parsing a fixed format document for one or more paragraphs containing one or more text runs;
determining a text run directionality for each of the one or more text runs;
parsing the fixed format document for one or more sections in the fixed format document, the sections containing one or more columns of text runs;
collecting each of the one or more text runs contained in the one or more paragraphs and in the one or more columns of text runs according to a text run directionality determined for each of the one or more text runs based on a right-to-left directionality or based on a left-to-right directionality; and
reconstructing the fixed format document as a flow format document wherein each of the one or more text runs reconstructed in the flow format document are reconstructed according to the designated text run directionality designated for each of the one or more text runs.

20. A system for detecting text direction in a fixed format document for reconstruction of a flow format document; comprising:
one or more processors; and
a memory coupled to the one or more processors, the one or more processors operable to:
break one or more lines comprising a fixed format document into one or more text runs, the one or more text runs including one or more of characters, glyphs, spaces, words, ligatures, diacritics associated with characters or glyphs or combinations thereof;
determine a right-to-left text run directionality or a left-to-right text run directionality for each of the one or more text runs;
collect each of the one or more text runs according to a right-to-left text run directionality or a left-to-right text run directionality determined for each of the one or more text runs; and
reconstruct the fixed format document as a flow format document wherein each of the one or more text runs reconstructed in the flow format document are reconstructed according to the designated text run directionality designated for each of the one or more text runs.
